(19) United States
(12) Patent Application Publication
(10) Pub. No.: US 2023/0302572 A1
(43) Pub. Date: Sep. 28, 2023

(54) LASER PROCESSING METHOD

(71) Applicant: Sodick Co., Ltd., Yokohama (JP)

(72) Inventors: Yoshinori OGAWA, El Cerrito, CA (US); Tetsuya IMAI, Yokohama (JP); Takeshi JIN, Yokohama (JP)

(73) Assignee: Sodick Co., Ltd., Yokohama (JP)

(21) Appl. No.: 17/700,793

(22) Filed: Mar. 22, 2022

(51) Int. Cl. B23K 26/0622; B23K 26/40

(52) U.S. Cl. CPC B23K 26/0624; B23K 26/40; B23K 2103/04

(57) ABSTRACT

A laser processing method that enables more precise processing using an ultrashort pulse laser. The laser processing method includes: a low fluence step of processing one or more layers to be processed sequentially from the workpiece by irradiating the layers to be processed with a pulse laser beam having a pulse width of less than 10 picoseconds at a predetermined low fluence; and a high fluence step of removing a protrusion generated on a surface of the layers to be processed by irradiation with the pulse laser beam at a high fluence higher than the low fluence, wherein the low fluence step and the high fluence step are repeated one or more times.

### TECHNICAL FIELD

The present invention relates to a laser processing method.

### BACKGROUND

When a workpiece is irradiated with an ultrashort pulse laser having a pulse width on the order of equal to or less than a single picosecond, a material in an irradiated area is non-thermally dispersed and removed (ablation). Ultrashort pulse laser processing utilizing such a phenomenon enables fine processing in an atom-sized order and also enables high-quality processing of a variety of materials because its thermal influence on the surrounding area of the irradiated portion is small. Patent Literature 1 discloses a method for manufacturing a diamond die for a wire electrode used in wire electrical discharge machining, which enables the formation of a die hole with high surface precision in a short time by processing using a femtosecond laser.

### PATENT LITERATURE

[Patent Literature 1] JP-B-6340459

### SUMMARY

When a portion of the workpiece to be processed is divided into a plurality of layers to be processed having a predetermined thickness, and the layers to be processed are sequentially processed by the irradiation with an ultrashort pulse laser, a protrusion having a substantially elliptical cross section may be generated on the surface of the layer to be processed during processing. The generation of such protrusions has been observed in a variety of materials including metals and resins. Further, once the protrusion is generated, the protrusion grows as the processing of the layers to be processed progresses. Thus, this may cause a decrease in processing quality, especially in the processing of a relatively deep bottomed hole and the like.

The present invention has been made in view of such circumstances, and an object of the present invention is to provide a laser processing method that enables more precise processing using an ultrashort pulse laser.

According to the present invention, provided is a laser processing method of a workpiece, comprising: a low fluence step of processing one or more layers to be processed sequentially from the workpiece by irradiating the layers to be processed with a pulse laser beam having a pulse width of less than 10 picoseconds at a predetermined low fluence; and a high fluence step of removing a protrusion generated on a surface of the layers to be processed by irradiation with the pulse laser beam at a high fluence higher than the low fluence, wherein the low fluence step and the high fluence step are repeated one or more times.

In the laser processing method according to the present invention, the low fluence step in which the layers to be processed are processed and the high fluence step in which the protrusion generated on the surface of the layers to be processed is removed are repeated one or more times to process the workpiece. With such a configuration, it is possible to avoid the growth of the protrusion by removing it at a relatively early stage after its generation and to finally obtain a high-precision processed surface.

Hereinafter, various embodiments of the present invention will be exemplified. The embodiments described below can be combined with each other.

Preferably, the layers to be processed are composed of an alloy steel containing an inclusion in a base material, and the high fluence is equal to or more than a laser ablation threshold of the inclusion.

### BRIEF DESCRIPTION OF DRAWINGS

FIG. 1 is a schematic configuration diagram of a laser processing device 1 according to an embodiment of the present invention.

FIG. 2A is a plan view of a workpiece 10 to be processed by the laser processing device 1.

FIG. 2B is a cross-sectional view of the workpiece 10 taken along an A-A line in FIG. 2A.

FIG. 3A to FIG. 3C are cross-sectional views in which layers to be processed of the workpiece 10 are processed by the laser processing device 1.

FIG. 4A and FIG. 4B are cross-sectional views showing the removal of protrusions 20 on a layer to be processed Lₖ by the laser processing device 1.

FIG. 5A is an image of a processed surface of a bottomed hole 10a in Example 1.

FIG. 5B is an image of a processed surface of the bottomed hole 10a in Comparative Example 1.

FIG. 6A is an image of a processed surface of the bottomed hole 10a formed in Comparative Example 2 and was obtained by imaging the bottomed hole 10a from above.

FIG. 6B is an enlarged image of a region B in FIG. 6A.

### DETAILED DESCRIPTION

Hereinafter, the embodiments of the present invention will be described with reference to the drawings. The characteristic matters shown in the embodiments described below can be combined with each other. Moreover, each characteristic matter independently constitutes an invention.

### <Laser Processing Device 1>

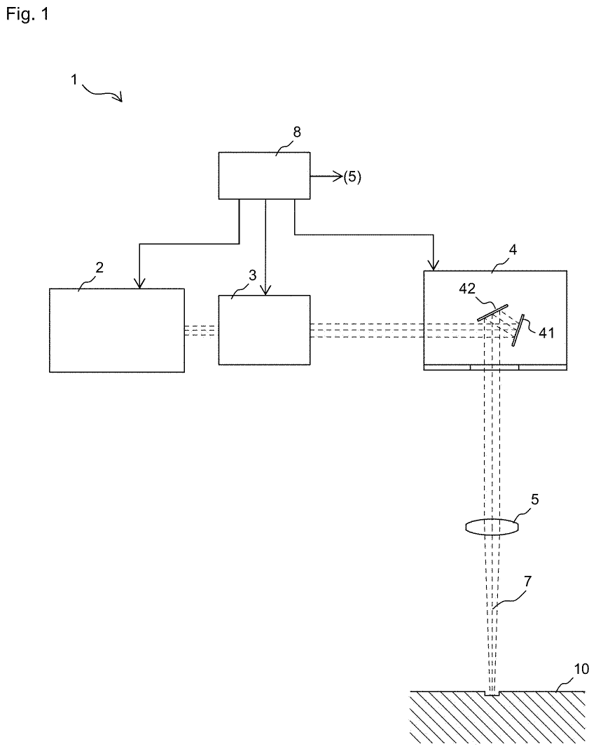

As shown in FIG. 1, a laser processing device 1 of the present embodiment irradiates a workpiece 10 with a pulse laser beam 7 having a pulse width of less than 10 picoseconds and processes the workpiece 10 into a desired shape by dispersing the material at the irradiated point. The laser processing device 1 incudes a laser oscillator 2, an optical system 3, a scanning device 4, a condensing lens 5, and a control device 8. The laser oscillator 2 converts a laser beam oscillated from a laser source (not shown) into the pulse laser beam 7 having a pulse width of less than 10 picoseconds and outputs it after adjusting its pulse energy into a predetermined value. In this regard, the pulse width refers to the time width per pulse of the pulse laser beam 7. The optical system 3 adjusts the beam diameter of the pulse laser beam 7 output from the laser oscillator 2 by means of a built-in lens (not shown). The optical system 3 can be configured using, for example, a beam expander.

In the processing using the pulse laser beam 7, a portion of the workpiece 10 to be processed is divided into one or more layers to be processed along its depth direction, and the layers to be processed are processed sequentially from a top surface side to process the workpiece 10 into the desired shape. The scanning device 4 two-dimensionally scans the pulse laser beam 7 on each layer to be processed of the workpiece 10. The scanning device 4 includes a first galvanometer mirror 41, a second galvanometer mirror 42, and actuators (not shown) that control the operation of the galvanometer mirrors 41,42, respectively. The pulse laser beam 7 output from the optical system 3 is scanned in a first direction, which is a horizontal one-axis direction, by being reflected by the first galvanometer mirror 41, and is scanned in a second direction, which is another horizontal one-axis direction orthogonal to the first direction, by being reflected by the second galvanometer mirror 42. Consequently, a predetermined point of the layer to be processed is irradiated with the pulse laser beam 7, and the material at the irradiated point is removed.

The condensing lens 5 adjusts the beam diameter of the pulse laser beam 7 output from the scanning device 4. The condensing lens 5 can be configured using an objective lens. The beam diameter is adjusted by the optical system 3 and the condensing lens 5, so that it becomes possible to irradiate the layer to be processed with the pulse laser beam 7 with a predetermined spot diameter (the beam diameter of the pulse laser beam 7 at the irradiated point on the layer to be processed).

The control device 8 is configured to control the above components. In this regard, the control device 8 may be realized by software or hardware. When realized by software, various functions can be realized by CPU executing computer programs. The program may be stored in a built-in memory or a non-transitory computer-readable storage medium. Alternatively, the above functions may be realized by reading the program stored in an external memory using so-called cloud computing. When realized by hardware, the above functions can be performed by various circuits such as ASIC (Application Specific Integrated Circuit), FPGA (Field Programmable Gate Array), or DRP (Dynamically Reconfigurable Processor). In the present embodiment, various information and concepts including this information are dealt with. The information and concepts can be represented as a bit group of binary numbers having 0 or 1 according to the level of signal value, and communication and calculation can be executed according to configurations of the above software and hardware.

A CAD device (not shown) and a CAM device (not shown) are installed outside the control device 8. The CAD device is configured to create three-dimensional shape data (CAD data) representing the processed shape and dimensions of the workpiece 10. The CAM device is configured to create operation procedure data (CAM data) of the laser processing device 1 when processing the workpiece 10. The CAM data include, for example, data on irradiation positions of the pulse laser beam 7 on each of the layers to be processed, and data on various settings related to the pulse laser beam 7 (for example, output pulse energy at the laser oscillator 2). The control device 8 reads the CAM data and outputs an operation command in the form of a signal or data of operation command values to the laser oscillator 2, the optical system 3, the scanning device 4, and the condensing lens 5.

### <Processing Method of Workpiece 10>

Next, a processing method of the workpiece 10 using the laser processing device 1 of the present embodiment will be described. The processing method of the workpiece 10 in the present embodiment includes a low fluence step and a high fluence step.

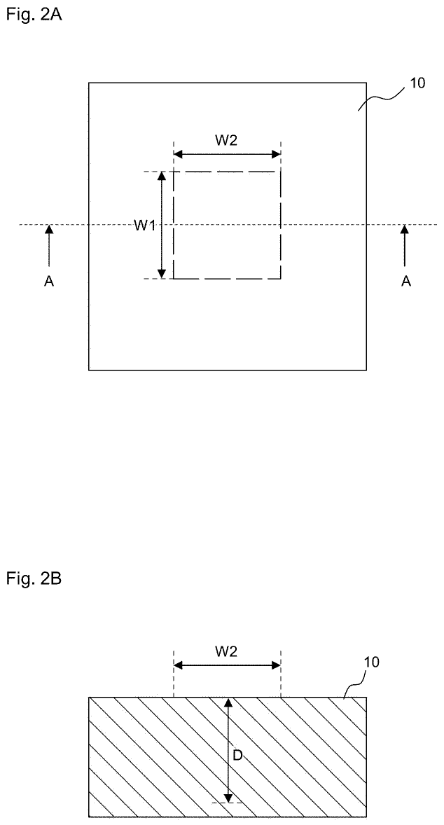

As an example of the processing by the laser processing device 1, a case of forming a bottomed hole 10a on the workpiece 10 shown in FIG. 2A and FIG. 2B will be described. The workpiece 10 is made of alloy steel, and the bottomed hole 10a to be formed has a rectangular opening having the size of W1×W2 in a plan view and has a depth of D.

In the present embodiment, the portion to be processed is divided into n layers L₁, L₂, L₃, . . . Lₙ to be processed from the top surface side of the workpiece 10. In this regard, the thickness of each of the layers L₁, L₂, L₃, . . . Lₙ to be processed may be the same or different from each other.

In the low fluence step, the workpiece 10 is irradiated with the pulse laser beam 7 at a relatively low fluence (low fluence FL) to sequentially process the layers L₁, L₂, L₃, . . . to be processed. In this regard, the fluence refers to the amount of energy per unit area in an irradiation spot of the pulse laser beam 7, and the fluence in the present invention refers to the fluence of the pulse laser beam 7 at the irradiated point on the layer to be processed. In the present embodiment, the value of the low fluence FL is set to be equal to or higher than a laser ablation threshold, which is the lower limit of fluence required for removal of the material constituting the layer to be processed (alloy steel). The control device 8 outputs the operation command to the laser oscillator 2 to adjust the output pulse energy so that the layer to be processed is irradiated with the pulse laser beam 7 at the low fluence FL.

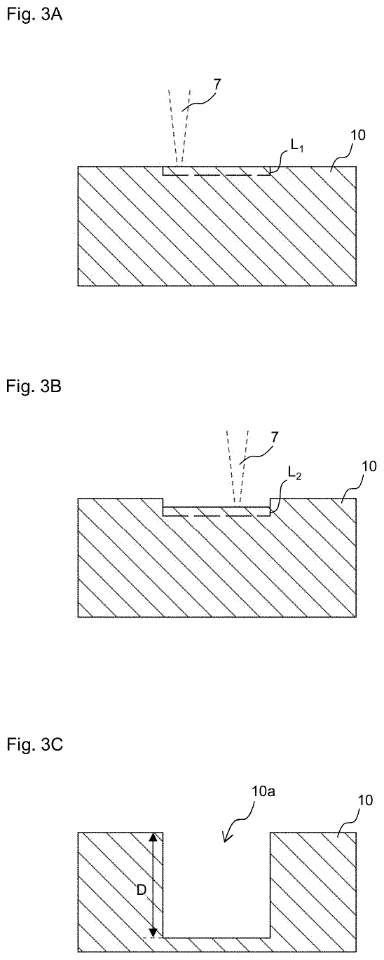

Specifically, as shown in FIG. 3A, the first (top) layer L₁ to be processed is irradiated with the pulse laser beam 7 at the low fluence FL to process the layer L₁. Next, as shown in FIG. 3B, the second layer L₂ to be processed located directly below the layer L₁ is irradiated with the pulse laser beam 7 at the low fluence FL to process the layer L₂. The same operation is repeated for the third and subsequent layers L₃, L₄ . . . to be processed to process the layers sequentially in the depth direction.

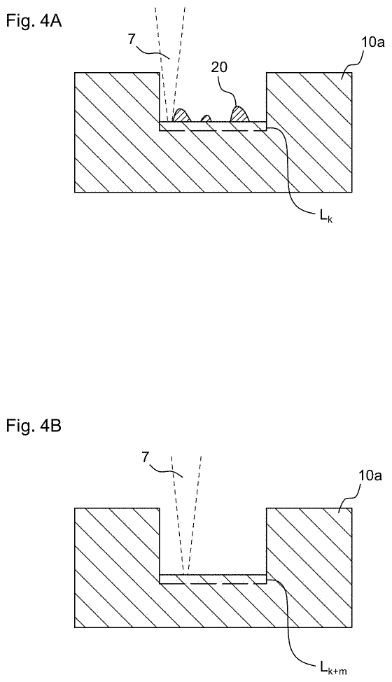

The high fluence step is performed to remove protrusions 20 when the protrusions 20 are generated on the surface of the layer to be processed as shown in FIG. 4A. When the protrusions 20 are generated on the k-th layer Lₖ to be processed, the layer Lₖ to be processed is irradiated with the pulse laser beam 7 at a fluence (high fluence FH) higher than the low fluence FL. The high fluence FH is a fluence of the pulse laser beam 7 at the irradiated point on the layer Lₖ to be processed and is higher than the low fluence FL. The control device 8 outputs the operation command to the laser oscillator 2 so that the layer to be processed is irradiated with the pulse laser beam 7 at the high fluence FH.

It is often difficult to remove the protrusions 20 generated on the surface of the layer to be processed during the processing of the layer to be processed by the irradiation with the pulse laser beam 7 at the low fluence FL, which is suitable for processing the layer to be processed. For example, in processing the workpiece 10 made of alloy steel, the protrusions 20 having a substantially elliptical cross section are generated due to inclusions contained in the alloy steel as the base material. Since the laser ablation threshold of the inclusions is much higher than the laser ablation threshold of alloy steel, it is difficult to remove the protrusions 20 by the irradiation with the pulse laser beam 7 at the low fluence FL suitable for the processing of the layer to be processed. Therefore, once the protrusion 20 is generated, the protrusion 20 grows in the depth direction as the layers to be processed are processed sequentially. Here, the inclusions refer to a small amount of non-metallic compounds that are inevitably mixed into alloy steel during its manufacturing process and are difficult to remove. The inclusions in alloy steel usually have a particle size of a few micrometers to several tens of micrometers and are irregularly distributed and contained in the alloy steel as the base material. Examples of the inclusions include oxide inclusions, such as Al₂O₃, MgO, CaO, sulfide inclusions, such as MnS, CaS, and nitride inclusions, such as TiN, NbN.

In the present embodiment, when the protrusion 20 is generated on the layer to be processed during the low fluence step, the high fluence step is performed to irradiate the layer to be processed with the pulse laser beam 7 at the high fluence FH higher than the low fluence FL, so that the protrusion 20 can be removed with the layer to be processed. If the high fluence FH is a times greater than the low fluence FL (i.e., FH=α×FL), the factor α can be set as, for example, 2≤α≤20, in particular, for example, α=2, 3, 4, 5, 6, 7, 8, 9, 10, 11, 12, 13, 14, 15, 16, 17, 18, 19, 20, and may be in the range between any two of the values exemplified herein. Further, in order to achieve both the removal efficiency of the protrusion 20 and suppression of the thermal influence on the material, it is preferably to set the high fluence FH so that the factor α satisfies the condition of 7≤α≤15. Further, when the material of the workpiece 10 is alloy steel, it is preferably to set the high fluence FH to be equal to or larger than the laser ablation threshold of the inclusions in order to efficiently remove the protrusion 20 originating from the inclusions.

The high fluence step is performed for one or more layers to be processed at least until the removal of the protrusions 20 is completed. In the present embodiment, the high fluence step is performed for m layers to be processed including the layer Lₖ to be processed to remove the protrusions 20. Then, as shown in FIG. 4B, the low fluence step is performed again for the (k+m)-th layer Lₖ₊ₘ to be processed, and the layers Lₖ₊ₘ, Lₖ₊ₘ₊₁, . . . to be processed are sequentially processed by the irradiation with the pulse laser beam 7 at the low fluence FL. When the protrusion 20 is generated again on the surface of the layer to be processed, the high fluence step is performed to remove the protrusion 20. By repeating the low fluence step and the high fluence step one or more times in this way to advance the processing to the n-th (lowest) layer Lₙ to be processed, the bottomed hole 10a having the desired depth D can be formed, as shown in FIG. 3C. In this regard, in order to improve the precision of a processed surface of the bottomed hole 10a, it is preferable to complete the processing by performing the final processing (processing to remove the portion including at least the n-th layer Lₙ to be processed) by the low fluence step after repeating the low fluence step and the high fluence step one or more times.

By repeating the low fluence step and the high fluence step on or more times, it is possible to avoid the growth of the protrusion 20 by removing it at a relatively early stage after the generation of the protrusion 20 on the surface of the layer to be processed and to finally obtain the bottomed hole 10a with a high-precision processed surface. In the present embodiment, the layers to be processed are sequentially processed in the low fluence step, the high fluence step is performed when the protrusion 20 is generated, and the low fluence step is restarted after the removal of the protrusion 20 is completed. In such a configuration, since the irradiation with the pulse laser beam 7 at a relatively high fluence FH is performed only when the protrusion 20 is generated, it is possible to remove the protrusion 20 while suppressing the thermal influence on the material of the workpiece 10.

### OTHER EMBODIMENTS

In this regard, while the formation of the bottomed hole having a rectangular opening in a plan view is described as an example in the above embodiment, the shape to be processed by applying the laser processing method of the present invention is not limited thereto. The shape of the opening of the bottomed hole and the shape of the cross section parallel to the opening surface of the opening may be other shapes, such as square and circular. Further, the laser processing method of the present invention is also applicable, for example, to the formation of a groove shape and surface finishing. Here, the groove shape refers to a shape in which at least one of the four sides of a recess is open.

Further, while the workpiece 10 made of alloy steel is processed in the above embodiment, the material of the workpiece 10 to which the laser processing method of the present invention is applied is not limited thereto. The laser processing method of the present invention is applicable, for example, to other metal materials, such as carbon steel, and resin materials.

### Example

Hereinafter, the details of the present invention will be described using examples. The present invention is not limited to the following examples.

Using the laser processing device 1, the ultrashort pulse laser processing was performed for the workpiece 10 to form the bottomed hole 10a, and the condition of the processed surface of the bottomed hole 10a was observed. In Example 1, the workpiece 10 made of SUS304 is irradiated with the pulse laser beam 7 (wavelength: 515 [nm], frequency: 200 [kHz]) having a pulse width of 410 [fs] by raster scanning at the scanning speed of 500 [mm/s], spot diameter of 9 [μm], spot spacing of 2.5 [μm], and line spacing 2.5 [μm]. Here, the spot spacing refers to the distance between the centers of two adjacent irradiation spots along the scanning direction (moving direction of the irradiation spot on the layer to be processed) of the pulse laser beam 7. Further, the line spacing refers to the distance between the centers of two adjacent irradiation spots in the horizontal one-axis direction orthogonal to the scanning direction of the pulse laser beam 7 in raster scanning.

In the low fluence step, the low fluence FL is set to 0.63 [J/cm²], the processing depth per layer is set to 0.36 [μm], and the layers to be processed were sequentially processed by the irradiation with the pulse laser beam 7. Further, in the high fluence step, the high fluence FH was set to 6.3 [J/cm²], the processing depth per layer was set to 1.5 [μm], and the protrusions 20 on the layer to be processed are removed with the layer to be processed by the irradiation with the pulse laser beam 7. The low fluence step and the high fluence step are repeated one or more times, and the final processing was performed by the low fluence step to finish the processing. Consequently, the bottomed hole 10a having a substantially square opening of 1000×1000 [μm] in a plan view and the depth of 481 [μm] was obtained.

In Comparative Example 1, the high fluence step was not performed, and the processing was performed only by the low fluence step. In the low fluence step, the low fluence FL was set to 0.63 [J/cm²], the processing depth per layer was set to 0.36 [μm], and the layers to be processed were sequentially processed by the irradiation with the pulse laser beam 7. The other conditions were set in the same way as in Example 1. The processing was completed by performing only the low fluence step, and the bottomed hole 10a having a substantially square opening of 1000×1000 [μm] and the depth of 477 [μm] was obtained.

In Comparative Example 2, the low fluence step was not performed, and the processing was performed only by the high fluence step. In the high fluence step, the high fluence FH was set to 6.3 [J/cm²], the processing depth per layer was set to 1.5 [μm], and the layers to be processed were sequentially processed by the irradiation with the pulse laser beam 7. The other conditions were set in the same way as in Example 1. The processing was completed by performing only the high fluence step, and the bottomed hole 10a having a substantially square opening of 1000×1000 [μm] and the depth of 468 [μm] was obtained.

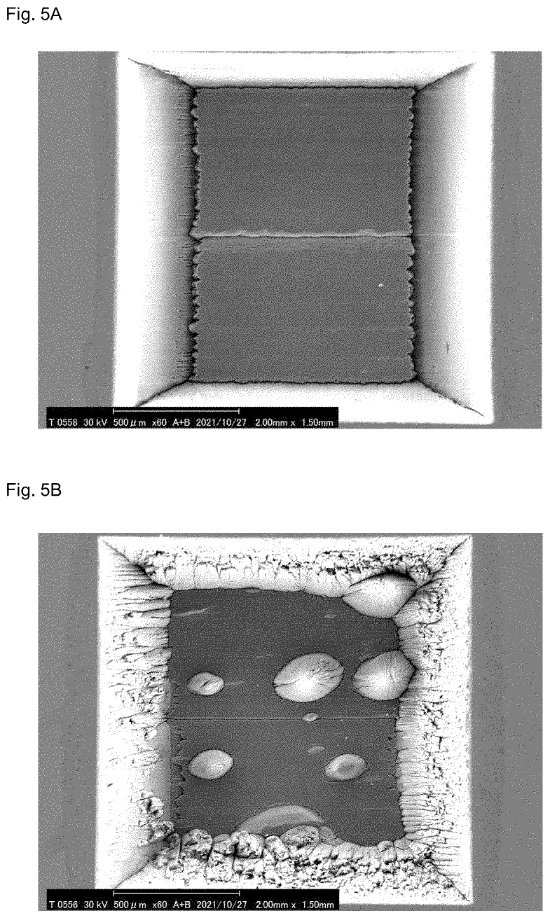

FIG. 5A and FIG. 5B are images of the processed surface of the bottomed hole 10a in Example 1 and Comparative Example 1, respectively and were obtained by imaging the bottomed hole 10a from above. In the bottomed hole 10a of Example 1, only a few small protrusions 20 were observed on a bottom and side surfaces. The arithmetic average roughness Ra, which is an index of surface roughness, of the processed surface was approximately 0.13 μm, and a relatively high-precision processed surface was obtained. In this regard, the arithmetic average roughness Ra was measured in accordance with JIS B 0601-2001. On the other hand, in the bottomed hole 10a of Comparative Example 1 formed only by the low fluence step, a large number of protrusions 20 were observed on the bottom and side surfaces, and the arithmetic average roughness Ra of the processed surface was approximately 2.0 μm.

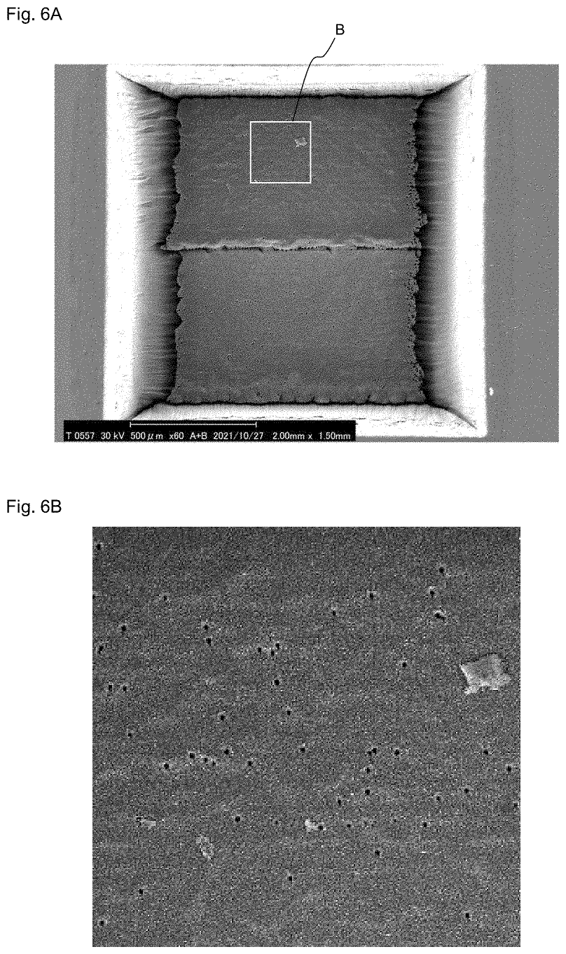

FIG. 6A is an image of the processed surface of the bottomed hole 10a formed in Comparative Example 2 and was obtained by imaging the bottomed hole 10a from above. FIG. 6B is an enlarged image of a region B in FIG. 6A. In the bottomed hole 10a of Comparative Example 2, almost no protrusions 20 were observed on the bottom and side surfaces. However, a large number of micropores caused by thermal influence were observed on the processed surface, and the arithmetic average roughness Ra of the processed surface was approximately 0.26 μm.

Various embodiments according to the present invention have been described above, and these are presented as examples and are not intended to limit the scope of the invention. The novel embodiment can be implemented in various other forms, and various omissions, replacements, and changes can be made without departing from the gist of the invention. The embodiment and its modifications are included in the scope and gist of the invention and are included in the scope of the invention described in the claims and the equivalent scope thereof.

### REFERENCE SIGNS LIST

1: laser processing device
2: laser oscillator
3: optical system
4: scanning device
5: condensing lens
7: pulse laser beam
8: control device
10: workpiece
10a: bottomed hole
20: protrusion
41: first galvanometer mirror
42: second galvanometer mirror

1. A laser processing method of a workpiece, comprising:
a low fluence step of processing one or more layers to be processed sequentially from the workpiece by irradiating the layers to be processed with a pulse laser beam having a pulse width of less than 10 picoseconds at a predetermined low fluence; and
a high fluence step of removing a protrusion generated on a surface of the layers to be processed by irradiation with the pulse laser beam at a high fluence higher than the low fluence,
wherein the low fluence step and the high fluence step are repeated one or more times.

2. The laser processing method of claim 1,
wherein the layers to be processed are composed of an alloy steel containing an inclusion in a base material, and
the high fluence is equal to or more than a laser ablation threshold of the inclusion.
